(19) United States
(12) Patent Application Publication
(10) Pub. No.: US 2025/0044118 A1
(43) Pub. Date: Feb. 6, 2025

(54) DYNAMICALLY UPDATING VEHICLE ROAD MAPS

(71) Applicant: GM Global Technology Operations LLC, Detroit, MI (US)

(72) Inventors: Michael Cui, Winnetka, CA (US); Hyukseong Kwon, Thousand Oaks, CA (US); Rodolfo Valiente Romero, Calabasas, CA (US); Marcus James Huber, Saline, MI (US); Alireza Esna Ashari Esfahani, Daly City, CA (US); Andrew Howe, Malibu, CA (US)

(21) Appl. No.: 18/362,109

(22) Filed: Jul. 31, 2023

(51) Int. Cl. G01C 21/00; G06V 10/774; G06V 10/82; G06V 20/56; G06V 20/58; G06V 20/70

(52) U.S. Cl. CPC G01C 21/3815; G01C 21/3841; G06V 10/774; G06V 10/82; G06V 20/58; G06V 20/588; G06V 20/70

(57) ABSTRACT

A system for updating a road map for a vehicle includes a plurality of vehicle sensors and a vehicle controller in electrical communication with the plurality of vehicle sensors. The vehicle controller is programmed to gather input data about an environment surrounding the vehicle using the plurality of vehicle sensors. The input data includes at least one abnormal traffic pattern indication. The vehicle controller is further programmed to generate an input label map based at least in part on the input data. The vehicle controller is further programmed to generate a vehicle output label map based at least in part on the input label map. The vehicle output label map is generated using a machine learning algorithm. The vehicle controller is further programmed to perform a first action based at least in part on the vehicle output label map.

### INTRODUCTION

The present disclosure relates to advanced driver assistance and automated driving systems and methods for vehicles, and more particularly, to systems and methods for updating road maps for a vehicle.

To increase occupant awareness and convenience, vehicles may be equipped with advanced driver assistance systems (ADAS) and/or automated driving systems (ADS). ADAS systems may use various sensors such as cameras, radar, and LiDAR to detect and identify objects around the vehicle, including other vehicles, pedestrians, road configurations, and traffic signs. ADAS systems may also use detailed road maps stored on-vehicle and/or off-vehicle to retrieve road configuration information. ADAS systems may take actions based on environmental conditions surrounding the vehicle, such as applying brakes or alerting an occupant of the vehicle. However, current ADS systems may not account for obstructions which may dynamically occur on roadways, causing the road configuration to differ from predetermined detailed road maps. For example, obstructions may appear on roadways due to motor vehicle accidents, road conditions such as potholes, buildup of precipitation due to adverse weather conditions, and/or the like.

Thus, while ADAS and ADS systems and methods achieve their intended purpose, there is a need for a new and improved system and method for updating road maps for a vehicle.

### SUMMARY

According to several aspects, a system for updating a road map for a vehicle is provided. The system includes a plurality of vehicle sensors and a vehicle controller in electrical communication with the plurality of vehicle sensors. The vehicle controller is programmed to gather input data about an environment surrounding the vehicle using the plurality of vehicle sensors. The input data includes at least one abnormal traffic pattern indication. The vehicle controller is further programmed to generate an input label map based at least in part on the input data. The vehicle controller is further programmed to generate a vehicle output label map based at least in part on the input label map. The vehicle output label map is generated using a machine learning algorithm. The vehicle controller is further programmed to perform a first action based at least in part on the vehicle output label map.

In another aspect of the present disclosure, the plurality of vehicle sensors includes at least one of a perception sensor and a vehicle communication system. To gather the input data, the vehicle controller is further programmed to receive the input data using at least one of the perception sensor and the vehicle communication system.

In another aspect of the present disclosure, the input data includes at least one or more remote vehicle location histories, one or more lane boundary locations, and the at least one abnormal traffic pattern indication.

In another aspect of the present disclosure, the at least one abnormal traffic pattern indication includes at least one of a deviation of the one or more remote vehicle location histories from the one or more lane boundary locations and one or more tire marks in the environment surrounding the vehicle.

In another aspect of the present disclosure, the input label map is a two-dimensional matrix of a plurality of cells. Each of the plurality of cells represents a portion of the environment surrounding the vehicle. Each of the plurality of cells includes a label based at least in part on the input data.

In another aspect of the present disclosure, to generate the vehicle output label map, the vehicle controller is further programmed to provide the input label map to an input layer of the machine learning algorithm. The machine learning algorithm is a generative adversarial network (GAN) algorithm configured to generate the vehicle output label map based on the input label map. To generate the vehicle output label map, the vehicle controller is further programmed to receive the vehicle output label map from an output layer of the machine learning algorithm. The vehicle output label map includes one or more updated lane boundary locations based at least in part on the at least one abnormal traffic pattern indication and one or more road-surface condition labels. Each of the one or more updated lane boundary locations includes a lane boundary confidence level.

In another aspect of the present disclosure, the machine learning algorithm is trained using a plurality of training input label maps. Each of the plurality of training input label maps has been generated based at least in part on a heuristic evaluation of a plurality of training input data.

In another aspect of the present disclosure, the system further may include an automated driving system in electrical communication with the vehicle controller. To perform the first action, the vehicle controller is further programmed to adjust an operation of the automated driving system based at least in part on the vehicle output label map.

In another aspect of the present disclosure, the plurality of vehicle sensors further includes a vehicle communication system. To perform the first action, the vehicle controller is further programmed to transmit the input data to a remote server system using the vehicle communication system. To perform the first action, the vehicle controller is further programmed to transmit the vehicle output label map to the remote server system using the vehicle communication system.

In another aspect of the present disclosure, the remote server system includes a server communication system and a server controller in electrical communication with the server communication system. The server controller is programmed to receive a plurality of input data from one or more vehicles using the server communication system. The server controller is further programmed to receive a plurality of vehicle output label maps from the one or more vehicles using the server communication system. The server controller is further programmed to generate a server output label map based at least in part on the plurality of input data from the one or more vehicles. The server controller is further programmed to generate a combined output label map based at least in part on the plurality of vehicle output label maps from the one or more vehicles and the server output label map. The server controller is further programmed to transmit the combined output label map to the one or more vehicles using the server communication system.

According to several aspects, a method for updating a road map is provided. The method includes gathering input data. The method also includes generating an input label map based at least in part on the input data. The method also includes generating a vehicle output label map based at least in part on the input label map. The vehicle output label map is generated using a machine learning algorithm. The method also includes performing a first action based at least in part on the vehicle output label map.

In another aspect of the present disclosure, gathering the input data further may include performing a plurality of measurements using a plurality of vehicle sensors. The plurality of vehicle sensors includes at least one perception sensor.

In another aspect of the present disclosure, gathering the input data further may include receiving the input data from one or more remote vehicles.

In another aspect of the present disclosure, gathering the input data further may include gathering input data, where the input data includes at least one or more remote vehicle location histories, one or more lane boundary locations, and at least one abnormal traffic pattern indication. The abnormal traffic pattern indication includes at least one of a deviation of the one or more remote vehicle location histories from the one or more lane boundary locations and one or more tire marks in an environment surrounding a vehicle.

In another aspect of the present disclosure, generating the input label map further may include generating the input label map, where the input label map is a two-dimensional matrix of a plurality of cells. Each of the plurality of cells represents a portion of the environment surrounding the vehicle. Each of the plurality of cells includes a label based at least in part on the input data.

In another aspect of the present disclosure, generating the vehicle output label map further may include providing the input label map to an input layer of the machine learning algorithm. The machine learning algorithm is a generative adversarial network algorithm configured to generate the vehicle output label map based on the input label map. Generating the vehicle output label map further may include receiving the vehicle output label map from an output layer of the machine learning algorithm. The vehicle output label map includes one or more updated lane boundary locations based at least in part on the at least one abnormal traffic pattern indication and one or more road-surface condition labels based at least in part on the at least one abnormal traffic pattern indication. Each of the one or more updated lane boundary locations includes a lane boundary confidence level.

In another aspect of the present disclosure, to generate the vehicle output label map, the vehicle controller is further programmed to provide the input label map to an input layer of the machine learning algorithm. The machine learning algorithm is a generative adversarial network algorithm configured to generate the vehicle output label map based on the input label map. To generate the vehicle output label map, the vehicle controller is further programmed to receive the vehicle output label map from an output layer of the machine learning algorithm. The vehicle output label map includes one or more updated lane boundary locations based at least in part on the at least one abnormal traffic pattern indication and one or more road-surface condition labels based at least in part on the at least one abnormal traffic pattern indication. Each of the one or more updated lane boundary locations includes a lane boundary confidence level. To generate the vehicle output label map, the vehicle controller is further programmed to wherein to generate the server output label map, the server controller is further programmed to provide the input label map to an input layer of the machine learning algorithm. The machine learning algorithm is a generative adversarial network algorithm configured to generate the server output label map based on the input label map. To generate the vehicle output label map, the vehicle controller is further programmed to receive the server output label map from an output layer of the machine learning algorithm. The server output label map includes one or more updated lane boundary locations based at least in part on the at least one abnormal traffic pattern indication and one or more road-surface condition labels based at least in part on the at least one abnormal traffic pattern indication. Each of the one or more updated lane boundary locations includes a lane boundary confidence level.

According to several aspects, a system for updating a road map for a vehicle is provided. The system includes a vehicle system including a plurality of vehicle sensors including at least a perception sensor and a vehicle communication system, an automated driving system, and a vehicle controller in electrical communication with the plurality of vehicle sensors and the automated driving system. The vehicle controller is programmed to gather input data about an environment surrounding the vehicle using the plurality of vehicle sensors. The input data includes at least one or more remote vehicle location histories, one or more lane boundary locations, and at least one abnormal traffic pattern indication. The abnormal traffic pattern indication includes at least one of a deviation of the one or more remote vehicle location histories from the one or more lane boundary locations and one or more tire marks in the environment surrounding the vehicle. The vehicle controller is programmed to generate an input label map based at least in part on the input data. The input label map is a two-dimensional matrix of a plurality of cells. Each of the plurality of cells represents a portion of the environment surrounding the vehicle. Each of the plurality of cells includes a label based at least in part on the input data. The vehicle controller is further programmed to generate a vehicle output label map based at least in part on the input label map. The vehicle output label map is generated using a machine learning algorithm. The vehicle controller is further programmed to adjust an operation of the automated driving system based at least in part on the vehicle output label map. The vehicle controller is programmed to transmit the input data to a remote server system using the vehicle communication system. The vehicle controller is further programmed to transmit the vehicle output label map to the remote server system using the vehicle communication system.

In another aspect of the present disclosure, the remote server system further may include a server communication system and a server controller in electrical communication with the server communication system. The server controller is programmed to receive a plurality of input data from the vehicle system using the server communication system. The server controller is further programmed to receive a plurality of vehicle output label maps from the vehicle system using the server communication system. The server controller is further programmed to generate a server output label map based at least in part on the plurality of input data from the vehicle system. The server controller is further programmed to generate a combined output label map based at least in part on the plurality of vehicle output label maps from the vehicle system and the server output label map. The server controller is further programmed to transmit the combined output label map to the vehicle system using the server communication system.

In another aspect of the present disclosure, to generate the vehicle output label map, the vehicle controller is further programmed to provide the input label map to an input layer of the machine learning algorithm. The machine learning algorithm is a generative adversarial network algorithm configured to generate the vehicle output label map based on the input label map. To generate the vehicle output label map, the vehicle controller is further programmed to receive the vehicle output label map from an output layer of the machine learning algorithm. The vehicle output label map includes one or more updated lane boundary locations based at least in part on the at least one abnormal traffic pattern indication and one or more road-surface condition labels based at least in part on the at least one abnormal traffic pattern indication. Each of the one or more updated lane boundary locations includes a lane boundary confidence level. To generate the vehicle output label map, the vehicle controller is further programmed to wherein to generate the server output label map, the server controller is further programmed to provide the input label map to an input layer of the machine learning algorithm. The machine learning algorithm is a generative adversarial network algorithm configured to generate the server output label map based on the input label map. To generate the vehicle output label map, the vehicle controller is further programmed to receive the server output label map from an output layer of the machine learning algorithm. The server output label map includes one or more updated lane boundary locations based at least in part on the at least one abnormal traffic pattern indication and one or more road-surface condition labels based at least in part on the at least one abnormal traffic pattern indication. Each of the one or more updated lane boundary locations includes a lane boundary confidence level.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a system for updating a road map for a vehicle, according to an exemplary embodiment;

FIG. 2 is a flowchart of a method for updating a road map for a vehicle, according to an exemplary embodiment;

FIG. 3 is a schematic diagram of an exemplary roadway environment, according to an exemplary embodiment;

FIG. 4 is a schematic diagram of an exemplary input label map, according to an exemplary embodiment;

FIG. 5 is a schematic diagram of an exemplary output label map, according to an exemplary embodiment;

FIG. 6 is a schematic diagram of an exemplary visual rendering of the output label map shown in FIG. 5, according to an exemplary embodiment;

FIG. 7 is a flowchart of a method for training a machine learning algorithm, according to an exemplary embodiment;

FIG. 8 is an exemplary heuristic slipperiness decision tree, according to an exemplary embodiment; and

FIG. 9 is an exemplary heuristic confidence decision tree, according to an exemplary embodiment.

### DETAILED DESCRIPTION

The following description is merely exemplary in nature and is not intended to limit the present disclosure, application, or uses.

In some instances, obstructions such as, for example, roadway defects (e.g., a pothole on or near the roadway), foreign objects (e.g., debris from a vehicular collision on or near the roadway), traffic-related obstructions (e.g., a disabled vehicle stopped on or near the roadway), construction-related obstructions (e.g., a construction zone closing and/or diverting lanes), weather-related obstructions (e.g., a snowbank on or near the roadway), and/or the like may dynamically appear on the roadway. Detailed maps of roadways stored on-vehicle and/or off-vehicle may not account for these obstructions. Accordingly, the present disclosure provides a new and improved system and method for updating and/or reconstructing a road map for a vehicle to integrate dynamic changes in roadway conditions.

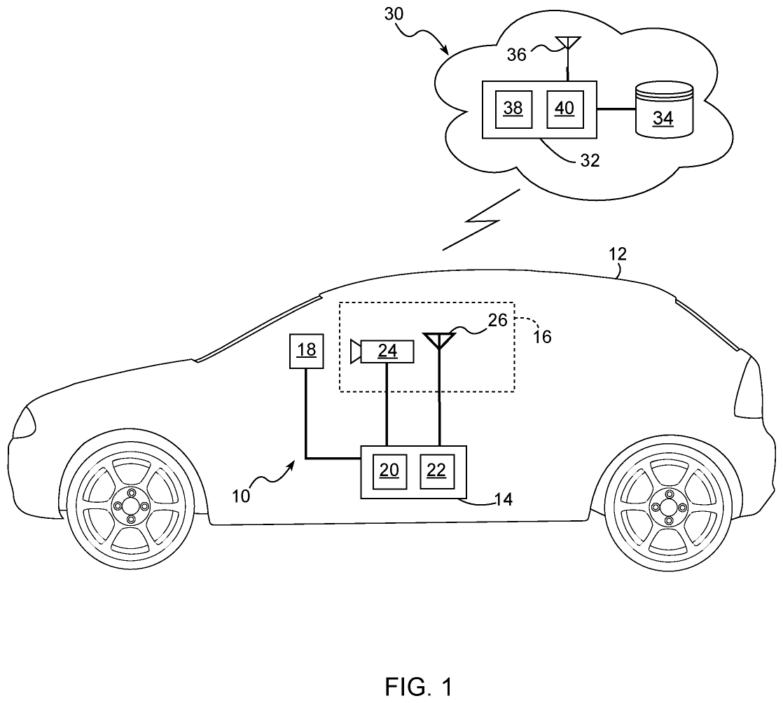

Referring to FIG. 1, a system for updating a road map for a vehicle is illustrated and generally indicated by reference number 10. The system 10 is shown with an exemplary vehicle 12. While a passenger vehicle is illustrated, it should be appreciated that the vehicle 12 may be any type of vehicle without departing from the scope of the present disclosure. The system 10 generally includes a vehicle controller 14, a plurality of vehicle sensors 16, and an automated driving system 18.

The vehicle controller 14 is used to implement a method 100 for updating a road map for a vehicle, as will be described below. The vehicle controller 14 includes at least one processor 20 and a non-transitory computer readable storage device or media 22. The processor 20 may be a custom made or commercially available processor, a central processing unit (CPU), a graphics processing unit (GPU), an auxiliary processor among several processors associated with the vehicle controller 14, a semiconductor-based microprocessor (in the form of a microchip or chip set), a macroprocessor, a combination thereof, or generally a device for executing instructions. The computer readable storage device or media 22 may include volatile and nonvolatile storage in read-only memory (ROM), random-access memory (RAM), and keep-alive memory (KAM), for example. KAM is a persistent or non-volatile memory that may be used to store various operating variables while the processor 20 is powered down. The computer-readable storage device or media 22 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the vehicle controller 14 to control various systems of the vehicle 12. The vehicle controller 14 may also consist of multiple vehicle controllers which are in electrical communication with each other. The vehicle controller 14 may be inter-connected with additional systems and/or vehicle controllers of the vehicle 12, allowing the vehicle controller 14 to access data such as, for example, speed, acceleration, braking, and steering angle of the vehicle 12.

The vehicle controller 14 is in electrical communication with the plurality of vehicle sensors 16 and the automated driving system 18. In an exemplary embodiment, the electrical communication is established using, for example, a CAN network, a FLEXRAY network, a local area network (e.g., WiFi, ethernet, and the like), a serial peripheral interface (SPI) network, or the like. It should be understood that various additional wired and wireless techniques and communication protocols for communicating with the vehicle controller 14 are within the scope of the present disclosure.

The plurality of vehicle sensors 16 are used to acquire information relevant to the vehicle 12. In an exemplary embodiment, the plurality of vehicle sensors 16 includes at least a camera system 24 and a vehicle communication system 26.

In another exemplary embodiment, the plurality of vehicle sensors 16 further includes sensors to determine performance data about the vehicle 12. In a non-limiting example, the plurality of vehicle sensors 16 further includes at least one of a motor speed sensor, a motor torque sensor, an electric drive motor voltage and/or current sensor, an accelerator pedal position sensor, a brake position sensor, a coolant temperature sensor, a cooling fan speed sensor, and a transmission oil temperature sensor.

In another exemplary embodiment, the plurality of vehicle sensors 16 further includes sensors to determine information about an environment within the vehicle 12. In a non-limiting example, the plurality of vehicle sensors 16 further includes at least one of a seat occupancy sensor, a cabin air temperature sensor, a cabin motion detection sensor, a cabin camera, a cabin microphone, and/or the like.

In another exemplary embodiment, the plurality of vehicle sensors 16 further includes sensors to determine information about the environment surrounding the vehicle 12. In a non-limiting example, the plurality of vehicle sensors 16 further includes at least one of an ambient air temperature sensor, a barometric pressure sensor, a global navigation satellite system (GNSS), and/or a photo and/or video camera which is positioned to view the environment in front of the vehicle 12.

In another exemplary embodiment, at least one of the plurality of vehicle sensors 16 is a perception sensor capable of perceiving objects and/or measuring distances in the environment surrounding the vehicle 12. In a non-limiting example, the plurality of vehicle sensors 16 includes a stereoscopic camera having distance measurement capabilities. In one example, at least one of the plurality of vehicle sensors 16 is affixed inside of the vehicle 12, for example, in a headliner of the vehicle 12, having a view through a windscreen of the vehicle 12. In another example, at least one of the plurality of vehicle sensors 16 is affixed outside of the vehicle 12, for example, on a roof of the vehicle 12, having a view of the environment surrounding the vehicle 12. It should be understood that various additional types of perception sensors, such as, for example, LiDAR sensors, ultrasonic ranging sensors, radar sensors, and/or time-of-flight sensors are within the scope of the present disclosure. The plurality of vehicle sensors 16 are in electrical communication with the vehicle controller 14 as discussed above.

The camera system 24 is a perception sensor used to capture images and/or videos of the environment surrounding the vehicle 12. In an exemplary embodiment, the camera system 24 includes a photo and/or video camera which is positioned to view the environment surrounding the vehicle 12. In a non-limiting example, the camera system 24 includes a camera affixed inside of the vehicle 12, for example, in a headliner of the vehicle 12, having a view through a windscreen. In another non-limiting example, the camera system 24 includes a camera affixed outside of the vehicle 12, for example, on a roof of the vehicle 12, having a view of the environment in front of the vehicle 12.

In another exemplary embodiment, the camera system 24 is a surround view camera system including a plurality of cameras (also known as satellite cameras) arranged to provide a view of the environment adjacent to all sides of the vehicle 12. In a non-limiting example, the camera system 24 includes a front-facing camera (mounted, for example, in a front grille of the vehicle 12), a rear-facing camera (mounted, for example, on a rear tailgate of the vehicle 12), and two side-facing cameras (mounted, for example, under each of two side-view mirrors of the vehicle 12). In another non-limiting example, the camera system 24 further includes an additional rear-view camera mounted near a center high mounted stop lamp of the vehicle 12.

It should be understood that camera systems having additional cameras and/or additional mounting locations are within the scope of the present disclosure. It should further be understood that cameras having various sensor types including, for example, charge-coupled device (CCD) sensors, complementary metal oxide semiconductor (CMOS) sensors, and/or high dynamic range (HDR) sensors are within the scope of the present disclosure. Furthermore, cameras having various lens types including, for example, wide-angle lenses and/or narrow-angle lenses are also within the scope of the present disclosure.

The vehicle communication system 26 is used by the vehicle controller 14 to communicate with other systems external to the vehicle 12. For example, the vehicle communication system 26 includes capabilities for communication with vehicles (“V2V” communication), infrastructure (“V2I” communication), remote systems at a remote call center (e.g., ON-STAR by GENERAL MOTORS) and/or personal devices. In general, the term vehicle-to-everything communication (“V2X” communication) refers to communication between the vehicle 12 and any remote system (e.g., vehicles, infrastructure, and/or remote systems). In certain embodiments, the vehicle communication system 26 is a wireless communication system configured to communicate via a wireless local area network (WLAN) using IEEE 802.11 standards or by using cellular data communication (e.g., using GSMA standards, such as, for example, SGP.02, SGP.22, SGP.32, and the like). Accordingly, the vehicle communication system 26 may further include an embedded universal integrated circuit card (eUICC) configured to store at least one cellular connectivity configuration profile, for example, an embedded subscriber identity module (eSIM) profile. The vehicle communication system 26 is further configured to communicate via a personal area network (e.g., BLUETOOTH) and/or near-field communication (NFC). However, additional or alternate communication methods, such as a dedicated short-range communications (DSRC) channel and/or mobile telecommunications protocols based on the 3rd Generation Partnership Project (3GPP) standards, are also considered within the scope of the present disclosure. DSRC channels refer to one-way or two-way short-range to medium-range wireless communication channels specifically designed for automotive use and a corresponding set of protocols and standards. The 3GPP refers to a partnership between several standards organizations which develop protocols s and standards for mobile telecommunications. 3GPP standards are structured as “releases”. Thus, communication methods based on 3GPP release 14, 15, 16 and/or future 3GPP releases are considered within the scope of the present disclosure. Accordingly, the vehicle communication system 26 may include one or more antennas and/or communication transceivers for receiving and/or transmitting signals, such as cooperative sensing messages (CSMs). The vehicle communication system 26 is configured to wirelessly communicate information between the vehicle 12 and another vehicle. Further, the vehicle communication system 26 is configured to wirelessly communicate information between the vehicle 12 and infrastructure or other vehicles. It should be understood that the vehicle communication system 26 may be integrated with the vehicle controller 14 (e.g., on a same circuit board with the vehicle controller 14 or otherwise a part of the vehicle controller 14) without departing from the scope of the present disclosure.

The automated driving system 18 is used to provide assistance to an occupant of the vehicle 12 to increase occupant awareness and/or control behavior of the vehicle 12. In the scope of the present disclosure, the automated driving system 18 encompasses systems which provide any level of assistance to the occupant (e.g., blind spot warning, lane departure warning, and/or the like) and systems which are capable of autonomously driving the vehicle 12 under some or all conditions (e.g., automated lane-keeping, adaptive cruise control, fully autonomous driving, and/or the like). It should be understood that all levels of driving automation defined by, for example, SAE J3016 (i.e., SAE LEVEL 0, SAE LEVEL 1, SAE LEVEL 2, SAE LEVEL 3, SAE LEVEL 4, and SAE LEVEL 5) are within the scope of the present disclosure.

In an exemplary embodiment, the automated driving system 18 is configured to detect and/or receive information about the environment surrounding the vehicle 12 and process the information to provide assistance to the occupant. In some embodiments, the automated driving system 18 is a software module executed on the vehicle controller 14. In other embodiments, the automated driving system 18 includes a separate automated driving system controller, similar to the vehicle controller 14, capable of processing the information about the environment surrounding the vehicle 12. In an exemplary embodiment, the automated driving system 18 may operate in a manual operation mode, a partially automated operation mode, and a fully automated operation mode.

In the scope of the present disclosure, the manual operation mode means that the automated driving system 18 provides warnings or notifications to the occupant but does not intervene or control the vehicle 12 directly. In a non-limiting example, the automated driving system 18 receives information from the plurality of vehicle sensors 16. Using techniques such as, for example, computer vision, the automated driving system 18 understands the environment surrounding the vehicle 12 and provides assistance to the occupant. For example, if the automated driving system 18 identifies, based on data from the plurality of vehicle sensors 16, that the vehicle 12 is likely to collide with a remote vehicle, the automated driving system 18 may use a display of the vehicle 12 (not shown) to provide a warning to the occupant.

In the scope of the present disclosure, the partially automated operation mode means that the automated driving system 18 provides warnings or notifications to the occupant and may intervene or control the vehicle 12 directly in certain situations. In a non-limiting example, the automated driving system 18 is additionally in electrical communication with components of the vehicle 12 such as a brake system, a propulsion system, and/or a steering system of the vehicle 12, such that the automated driving system 18 may control the behavior of the vehicle 12. In a non-limiting example, the automated driving system 18 may control the behavior of the vehicle 12 by applying brakes of the vehicle 12 to avoid an imminent collision. In another non-limiting example, the automated driving system 18 may control the steering system of the vehicle 12 to provide an automated lane-keeping feature. In another non-limiting example, the automated driving system 18 may control the brake system, propulsion system, and steering system of the vehicle 12 to temporarily drive the vehicle 12 towards a predetermined destination. However, intervention by the occupant may be required at any time. In an exemplary embodiment, the automated driving system 18 may include additional components such as, for example, an eye tracking device configured to monitor an attention level of the occupant and ensure that the occupant is prepared to take over control of the vehicle 12.

In the scope of the present disclosure, the fully automated operation mode means that the automated driving system 18 uses data from the plurality of vehicle sensors 16 to understand the environment and control the vehicle 12 to drive the vehicle 12 to a predetermined destination without a need for control or intervention by the occupant.

The automated driving system 18 operates using a path planning algorithm which is configured to generate a safe and efficient trajectory for the vehicle 12 to navigate in the environment surrounding the vehicle 12. In an exemplary embodiment, the path planning algorithm is a machine learning algorithm trained to output control signals for the vehicle 12 based on input data collected from the plurality of vehicle sensors 16. In another exemplary embodiment, the path planning algorithm is a deterministic algorithm which has been programmed to output control signals for the vehicle 12 based on data collected from the plurality of vehicle sensors 16.

In a non-limiting example, the path planning algorithm generates a sequence of waypoints or a continuous path that the vehicle 12 should follow to reach a destination while adhering to rules, regulations, and safety constraints. The sequence of waypoints or continuous path is generated based at least in part on a detailed map and a current state of the vehicle 12 (i.e., position, velocity, and orientation of the vehicle 12). The detailed map includes, for example, information about lane boundaries, road geometry, speed limits, traffic signs, and/or other relevant features. In an exemplary embodiment, the detailed map is stored in the media 22 of the vehicle controller 14 and/or on a remote database or server. In another exemplary embodiment, the path planning algorithm performs perception and mapping tasks to interpret data collected from the plurality of vehicle sensors 16 and create, update, reconstruct, and/or augment the detailed map, as will be discussed in greater detail below.

It should be understood that the automated driving system 18 may include any software and/or hardware module configured to operate in the manual operation mode, the partially automated operation mode, or the fully automated operation mode as described above.

With continued reference to FIG. 1, a remote server system is illustrated and generally indicated by reference number 30. The remote server system 30 includes a server controller 32 in electrical communication with a server database 34 and a server communication system 36. In a non-limiting example, the remote server system 30 is located in a server farm, datacenter, or the like, and connected to the internet.

The server controller 32 includes at least one server processor 38 and a server non-transitory computer readable storage device or server media 40. The description of the type and configuration given above for the vehicle controller 14 also applies to the server controller 32. In some examples, the server controller 32 may differ from the vehicle controller 14 in that the server controller 32 is capable of a higher processing speed, includes more memory, includes more inputs/outputs, and/or the like. In a non-limiting example, the server processor 38 and server media 40 of the server controller 32 are similar in structure and/or function to the processor 20 and the media 22 of the vehicle controller 14, as described above.

The server database 34 is used to store detailed maps of roadways, including, for example, information about lane boundaries, road geometry, speed limits, traffic signs, and/or other relevant features. In an exemplary embodiment, the server database 34 includes one or more mass storage devices, such as, for example, hard disk drives, magnetic tape drives, magneto-optical disk drives, optical disks, solid-state drives, and/or additional devices operable to store data in a persisting and machine-readable fashion. In some examples, the one or more mass storage devices may be configured to provide redundancy in case of hardware failure and/or data corruption, using, for example, a redundant array of independent disks (RAID). In a non-limiting example, the server controller 32 may execute software such as, for example, a database management system (DBMS), allowing data stored on the one or more mass storage devices to be organized and accessed.

The server communication system 36 is used to communicate with external systems, such as, for example, the vehicle controller 14 via the vehicle communication system 26. In a non-limiting example, server communication system 36 is similar in structure and/or function to the vehicle communication system 26, as described above. In some examples, the server communication system 36 may differ from the vehicle communication system 26 in that the server communication system 36 is capable of higher power signal transmission, more sensitive signal reception, higher bandwidth transmission, additional transmission/reception protocols, and/or the like.

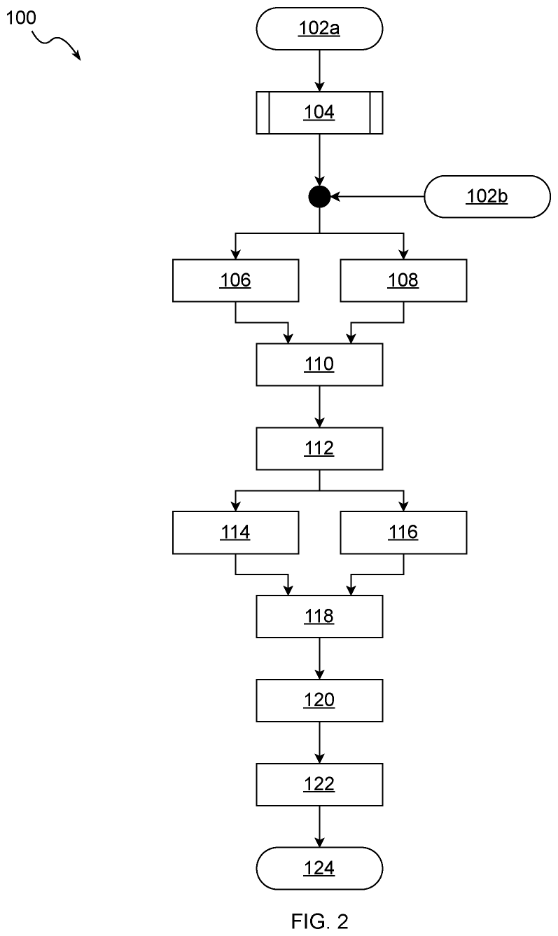

Referring to FIG. 2, a flowchart of the method 100 for updating a road map for a vehicle is shown. The method 100 begins at block 102a and proceeds to block 104. At block 104, a machine learning algorithm is trained, as will be discussed in greater detail below. After block 104, the method 100 proceeds to blocks 106 and 108.

At blocks 106 and 108, the vehicle controller 14 gathers input data about the environment surrounding the vehicle 12. In the scope of the present disclosure, the input data includes, for example, one or more remote vehicle location histories (i.e., past locations of remote vehicles traversing the environment), one or more lane boundary locations (i.e., location, type, color, and/or the like of lane edge and/or center line markings), and at least one abnormal traffic pattern indication. In the scope of the present disclosure, the at least one abnormal traffic pattern indication is one or more aspects of the input data which indicate that traffic flow is deviating from an expected traffic flow based on lane boundaries, traffic signs, road configuration, and/or the like.

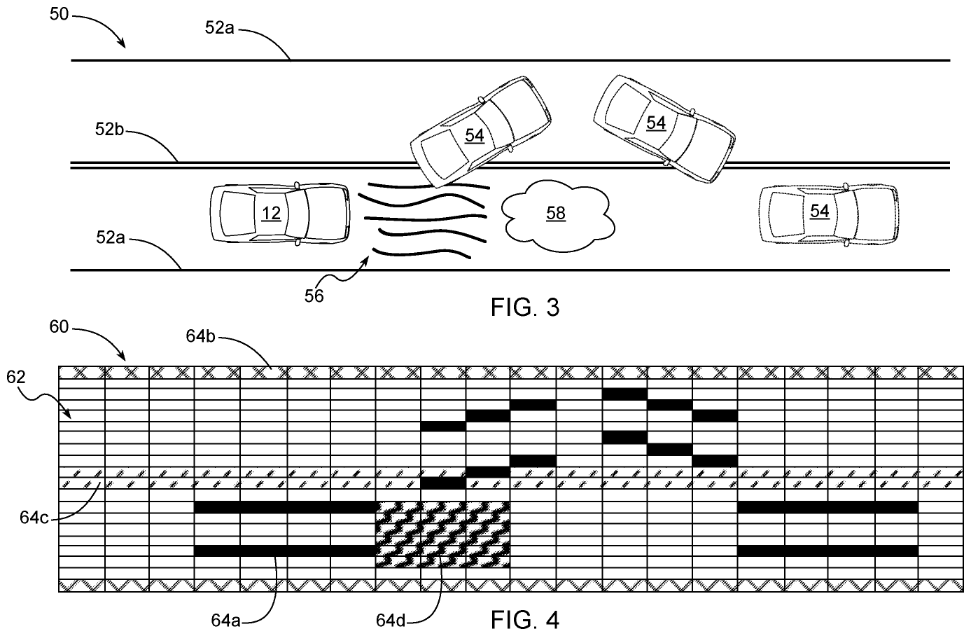

Referring to FIG. 3, a schematic diagram of an exemplary roadway environment 50 is shown. The exemplary roadway environment 50 includes outer lane boundaries 52a and an inner lane boundary 52b (i.e., a center lane line). The exemplary roadway environment 50 also includes the vehicle 12 and a remote vehicle location history 54, represented by a plurality of vehicles. Each of the plurality of vehicles represents a past location of a remote vehicle. The exemplary roadway environment 50 also includes tire marks 56 on the roadway. The exemplary roadway environment 50 also includes an obstruction 58 on the roadway. In the scope of the present disclosure, the obstruction 58 is any object or situation which may impede traffic and/or cause drivers to exhibit unexpected behavior. In a non-limiting example, the obstruction 58 may be a roadway defect (e.g., a pothole on or near the roadway), a foreign object (e.g., debris from a vehicular collision on or near the roadway), a traffic-related obstruction (e.g., a disabled vehicle stopped on or near the roadway), a weather-related obstruction (e.g., a snowbank on or near the roadway), and/or the like.

As shown in FIG. 3, the remote vehicle location history 54 shows that remote vehicles have deviated from the one or more lane boundaries (i.e., exited a proper lane of travel and encroached on an oncoming lane of travel) to avoid the obstruction 58. Therefore, in the exemplary roadway environment 50, the remote vehicle location history 54 is an example of the at least one abnormal traffic pattern indication. The tire marks 56 indicate loss of traction due to, for example, sudden braking, acceleration, and/or turning. The tire marks 56 may also indicate a portion of the roadway surface having reduced traction due to environmental conditions, roadway surface conditions, and/or the like. Therefore, in the exemplary roadway environment 50, the tire marks 56 are another example of the at least one abnormal traffic pattern indication.

It should be understood that FIG. 3 and the exemplary roadway environment 50 are merely examples, and that various additional roadway configurations, conditions, and situations (e.g., roadways including multiple lanes of travel, intersections, traffic control devices, and/or the like) are within the scope of the present disclosure.

Referring again to FIG. 2, at block 106, the vehicle controller 14 uses at least one perception sensor of the plurality of vehicle sensors 16 (e.g., the camera system 24) to gather the input data. In an exemplary embodiment, the vehicle controller 14 uses the camera system 24 to capture a plurality of images of the environment surrounding the vehicle 12. The vehicle controller 14 then uses a computer vision algorithm to analyze the plurality of images and extract the input data. In an exemplary embodiment, the computer vision algorithm utilizes machine learning techniques to analyze pixel-level information of the plurality of images to detect and classify objects or patterns of interest. In a non-limiting example, the computer vision algorithm begins by preprocessing the plurality of images through techniques such as, for example, image resizing, normalization, and/or filtering to reduce noise. Subsequently, the computer vision algorithm extracts relevant features from the plurality of images using methods such as, for example, edge detection, corner detection, texture analysis, and/or the like. The computer vision algorithm may then utilize a machine learning model, such as, for example, a convolutional neural network (CNN), to classify and label relevant features of the plurality of images (i.e., the one or more remote vehicle location histories, the one or more lane boundary locations, and the at least one abnormal traffic pattern indication) based on learned patterns and associations. After block 106, the method 100 proceeds to block 110, as will be discussed in greater detail below.

At block 108, the vehicle controller 14 uses the vehicle communication system 26 of the plurality of vehicle sensors 16 to gather the input data. In an exemplary embodiment, the vehicle controller 14 uses the vehicle communication system 26 to receive one or more vehicle-to-vehicle (V2V) messages from one or more remote vehicles. The one or more V2V messages include the input data. In a non-limiting example, the one or more remote vehicles may gather the input data using perception sensors and subsequently transmit the input data to the vehicle communication system 26 using the one or more V2V messages. In another exemplary embodiment, the vehicle controller 14 uses the vehicle communication system 26 to receive one or more vehicle-to-infrastructure (V2I) messages from one or more remote systems (e.g., the remote server system 30). The one or more V2I messages include the input data. After block 108, the method 100 proceeds to block 110.

Referring to FIG. 4, a schematic diagram of an exemplary input label map 60 corresponding to the exemplary roadway environment 50 is shown. With reference to FIG. 4 and continued reference to FIG. 2, at block 110, the vehicle controller 14 generates the input label map 60. In an exemplary embodiment, the input label map 60 is a two-dimensional matrix of a plurality of cells 62 representing the input data gathered at blocks 106 and 108. Each of the plurality of cells 62 represents a portion of the environment. Each of the plurality of cells 62 includes a label based at least in part on the input data gathered at blocks 106 and 108. In an exemplary embodiment, the label of each of the plurality of cells 62 indicates a presence of an object and/or roadway condition within the portion of the environment represented by each of the plurality of cells 62.

In FIG. 4, the label of each of the plurality of cells 62 is represented by a fill pattern of the each of the plurality of cells 62. Solid black filled cells 64a represent locations of vehicles and/or the remote vehicle location history 54. Crosshatch filled cells 64b represent outer lane boundaries 52a. Dash filled cells 64c represent the inner lane boundary 52b. Zigzag filled cells 64d represent the tire marks 56. It should be understood that the labels depicted in FIG. 4 are merely exemplary in nature, and that various additional labels may be applied to the plurality of cells 62, including, for example, labels indicating traffic control devices, intersection type, roadway surface condition, lane designation (e.g., right turn only lane), and/or the like within the scope of the present disclosure. It should also be understood that each of the plurality of cells 62 may include multiple labels without departing from the scope of the present disclosure.

In an exemplary embodiment, the vehicle controller 14 generates the input label map 60 using a computer vision algorithm, similar to the computer vision algorithm discussed above, to segment the environment into the plurality of cells 62 and assign a label to each of the plurality of cells 62. After block 110, the method 100 proceeds to block 112.

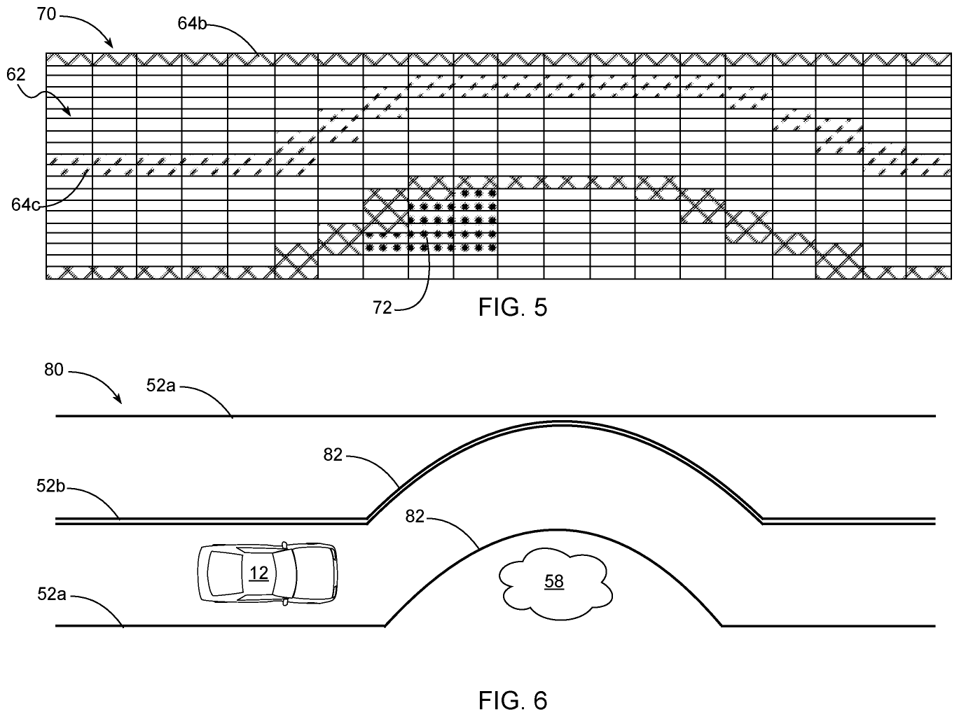

Referring to FIG. 5, a schematic diagram of an exemplary vehicle output label map 70 corresponding to the exemplary input label map 60 is shown. With reference to FIG. 5 and continued reference to FIG. 2, at block 112, the vehicle controller 14 generates the vehicle output label map 70. In an exemplary embodiment, the vehicle output label map 70 is similar to the input label map 60 in that the vehicle output label map 70 is a two-dimensional matrix of a plurality of cells 62. Each of the plurality of cells 62 represents a portion of the environment. Each of the plurality of cells 62 includes a label.

However, in contrast to the input label map 60, the vehicle output label map 70 includes one or more updated lane boundary locations based at least in part on the at least one abnormal traffic pattern indication. For example, as shown in FIG. 5, the locations of the outer lane boundaries 52a and the inner lane boundaries 52b have been adjusted based on the abnormal traffic pattern indication in the input data (i.e., the remote vehicle location history 54 showing that remote vehicles have deviated from the one or more lane boundaries). Each of the one or more updated lane boundary locations includes a lane boundary confidence level. The lane boundary confidence level is an additional label for each of the plurality of cells 62 corresponding to one of the one or more updated lane boundary locations. The lane boundary confidence level indicates a confidence in the one or more updated lane boundary locations, as will be discussed in greater detail below. The vehicle output label map 70 also includes one or more road-surface condition labels based at least in part on the at least one abnormal traffic pattern indication. For example, as shown in FIG. 5, because of the presence of the tire marks 56, some of the plurality of cells 62 have been labeled with a slipperiness condition label 72. In the scope of the present disclosure, the slipperiness condition label 72 indicates a relative slipperiness of the roadway surface, as will be discussed in greater detail below.

Referring to FIG. 6, a schematic diagram of an exemplary visual rendering 80 of the vehicle output label map 70 is shown. The exemplary visual rendering 80 of the vehicle output label map 70 includes updated lane boundary locations 82 which avoid the obstruction 58.

Referring again to FIG. 2, in an exemplary embodiment, the vehicle output label map 70 is generated using the machine learning algorithm trained at block 104. In a non-limiting example, the input label map 60 is provided to an input layer of the machine learning algorithm and the vehicle output label map 70 is received from an output layer of the machine learning algorithm. The function of the machine learning algorithm will be discussed in greater detail below. After block 112, the method 100 proceeds to blocks 114 and 116.

At block 114, the vehicle controller 14 adjusts an operation of the automated driving system 18 based at least in part on the vehicle output label map 70. In an exemplary embodiment, the one or more updated lane boundary locations and/or the one or more road-surface condition labels are used to update the detailed map used by the path planning algorithm of the automated driving system 18, as discussed above. Thus, based on the one or more updated lane boundary locations and/or the one or more road-surface condition labels, the operation of the automated driving system 18 is adjusted. In a non-limiting example, the lane departure warning and/or automated lane-keeping features of the automated driving system 18 are adjusted based on the one or more updated lane boundary locations. In another non-limiting example, the fully automated operation mode of the automated driving system 18 is adjusted based on the updated detailed map, such that the automated driving system 18 avoids the obstruction 58 and accounts for unexpected behavior of remote vehicles on the roadway. After block 114, the method 100 proceeds to block 118, as will be discussed in greater detail below.

At block 116, the vehicle controller 14 uses the vehicle communication system 26 to transmit both the input data gathered at blocks 106 and 108 and the vehicle output label map 70 to the remote server system 30. In an exemplary embodiment, the remote server system 30 receives the input data and the vehicle output label map 70 using the server communication system 36. In a non-limiting example, the server controller 32 saves the received input data and vehicle output label map 70 in the server database 34. In an exemplary embodiment, many vehicles are performing the method 100. Therefore, the server database 34 accumulates a plurality of input data and a plurality of vehicle output label maps from one or more vehicles. After block 116, the method proceeds to block 118.

At block 118, the remote server system 30 uses the server controller 32 to generate a server output label map based at least in part on the plurality of input data in the server database 34. The server output label map is generated in an analogous manner to the process of generating the vehicle output label map, including the steps discussed above in reference to blocks 110 and 112. However, the server output label map is generated based on the plurality of input data in the server database 34. After block 118, the method 100 proceeds to block 120.

At block 120, the server controller 32 generates a combined output label map. The combined output label map is based on the plurality of vehicle output label maps in the server database 34 and the server output label map generated at block 118. In an exemplary embodiment, the combined output label map is one of the plurality of vehicle output label maps in the server database 34 and the server output label map generated at block 118 having a highest total lane boundary confidence level. In another exemplary embodiment, the combined output label map is a fusion, concatenation, or otherwise a combination of one or more of the plurality of vehicle output label maps in the server database 34 and the server output label map generated at block 118. After block 120, the method 100 proceeds to block 122.

At block 122, the server controller 32 uses the server communication system 36 to transmit the combined output label map generated at block 120 to one or more vehicles (e.g., the vehicle 12). In an exemplary embodiment, the combined output label map is received by the vehicle communication system 26, stored in the media 22 of the vehicle controller 14, and used to adjust the operation of the automated driving system 18. After block 122, the method 100 proceeds to enter a standby state at block 124.

In an exemplary embodiment, the method 100 is repeatedly executed. In a non-limiting example, upon subsequent executions of the method 100, instead of beginning at block 102a, the method 100 begins at block 102b. This is because the training step performed at block 104 must only be performed once to initially train the machine learning model. In an exemplary embodiment, the method 100 exits the standby state 124 and restarts the method 100 at block 102b at regular intervals, for example, every three hundred milliseconds.

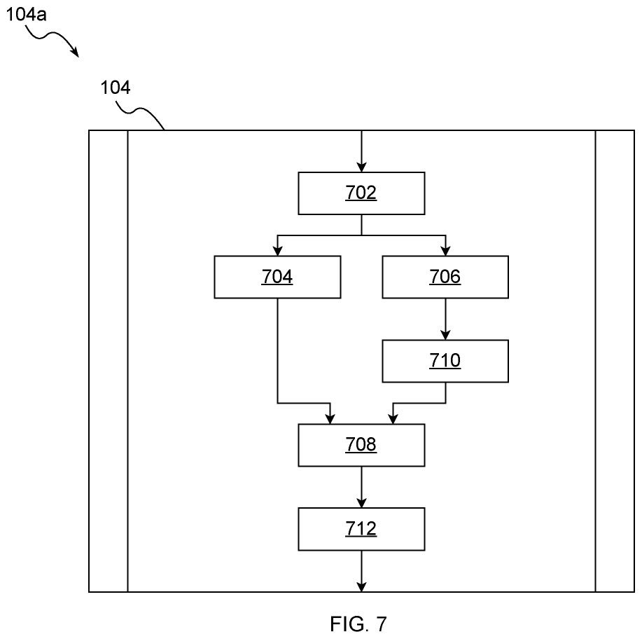

Referring to FIG. 7, a flowchart of an exemplary embodiment 104a of block 104 for training the machine learning algorithm is shown. In an exemplary embodiment, the following method steps of the exemplary embodiment 104a are performed by one or more components of the system 10 and/or the remote server system 30. The exemplary embodiment 104a begins at block 702. At block 702, a plurality of training input data is gathered. The training input data is similar to the input data gathered at blocks 106 and 108, as discussed above. Accordingly, the training input data includes, for example, one or more remote vehicle location histories (i.e., past locations of remote vehicles traversing the environment), one or more lane boundary locations (i.e., location, type, color, and/or the like of lane edge and/or center line markings), and at least one abnormal traffic pattern indication. The at least one abnormal traffic pattern indication is one or more aspects of the training input data which indicate that traffic flow is deviating from an expected traffic flow based on lane boundaries, traffic signs, road configuration, and/or the like. In an exemplary embodiment, the plurality of training input data includes training input data gathered from one or more vehicles. After gathering the training input data, a plurality of training input label maps are generated. Each of the plurality of training input label maps is generated in a similar manner to the input label map generated at block 110, as discussed above. After block 702, the exemplary embodiment 104a proceeds to blocks 704 and 706.

At block 704, a slipperiness condition label for each of the plurality of cells of each of the plurality of training input label maps is determined. In the scope of the present disclosure, the slipperiness condition label indicates a relative slipperiness of the roadway surface. In a non-limiting example, the slipperiness condition label includes one of: a low slipperiness, a medium slipperiness, and a high slipperiness. In an exemplary embodiment, the slipperiness condition label is determined using a heuristic (i.e., rules-based) evaluation of the plurality of training input data.

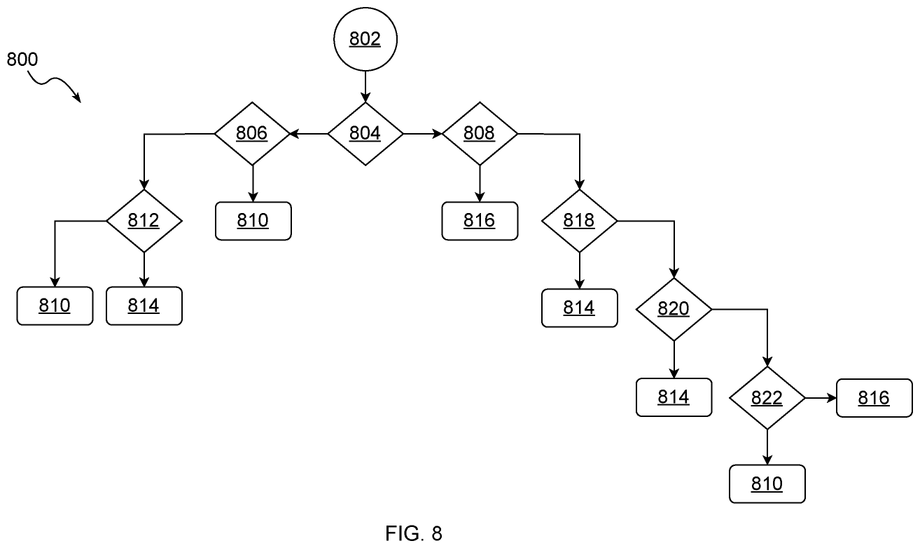

Referring to FIG. 8, an exemplary heuristic slipperiness decision tree 800 for determining a slipperiness condition label for a given one of the plurality of cells of one of the plurality of training input label maps (hereinafter referred to as “the given cell”) is shown. The slipperiness decision tree 800 begins at block 802 and proceeds to block 804. At block 804, if tire marks (e.g., the tire marks 56) are present in the given cell, the slipperiness decision tree 800 proceeds to block 806. If tire marks are not present in the given cell, the slipperiness decision tree 800 proceeds to block 808, as will be discussed in greater detail below.

At block 806, if the tire marks present in the given cell are organized (i.e., arranged in a consistent pattern, for example, parallel to adjacent tire marks), the slipperiness condition label of the given cell is determined to be the medium slipperiness at block 810. If the tire marks present in the given cell are not organized, the slipperiness decision tree 800 proceeds to block 812. At block 812, if the tire marks present in the given cell are unorganized (i.e., arranged in an inconsistent pattern, for example, where many tire marks are partially or fully perpendicular to other tire marks), the slipperiness condition label of the given cell is determined to be the high slipperiness at block 814.

Otherwise, if the tire marks present in the given cell are not unorganized, for example, if the tire marks are sporadic, sparse, or faded, the slipperiness condition label of the given cell is determined to be the medium slipperiness at block 810.

At block 808, if vehicles are observed to be moving within the given cell, the slipperiness condition label of the given cell is determined to be the low slipperiness at block 816. If vehicles are not observed to be moving within the given cell, the slipperiness decision tree 800 proceeds to block 818. At block 818, if vehicles are observed to be sliding (i.e., losing traction) within the given cell, the slipperiness condition label of the given cell is determined to be the high slipperiness at block 814. If vehicles are not observed to be sliding within the given cell, the slipperiness decision tree 800 proceeds to block 820.

At block 820, if vehicles are observed to be noticeably spinning out (i.e., moving with an unintended rotation) within the given cell, the slipperiness condition label of the given cell is determined to be the high slipperiness at block 814. If vehicles are not observed to be noticeably spinning out within the given cell, the slipperiness decision tree 800 proceeds to block 822. At block 822, if vehicles are observed to be developing a spin out condition (i.e., developing an unintended rotation) within the given cell, the slipperiness condition label of the given cell is determined to be the medium slipperiness at block 810. If vehicles are not observed to be developing a spin out condition within the given cell, the slipperiness condition label of the given cell is determined to be the low slipperiness at block 816.

Referring again to FIG. 3, after block 704, the exemplary embodiment 104a proceeds to block 708, as will be discussed in greater detail below.

At block 706, one or more updated lane boundary locations are determined. In an exemplary embodiment, the one or more updated lane boundary locations are determined based at least in part on the training input data gathered at block 702. For example, if the training input data includes one or more remote vehicle location histories deviating from one or more lane boundary locations detected on the roadway, the one or more updated lane boundary locations reflects a “new path” of the roadway which accounts for unexpected driving paths of the one or more remote vehicles. Each of the one or more updated lane boundary locations includes an associated lane boundary confidence level. In the scope of the present disclosure, the lane boundary confidence level represents a confidence that the updated lane boundary location is correct, based at least in part on the training input data, as will be discussed in greater detail below. After block 706, the exemplary embodiment 104a proceeds to block 710.

At block 710, the lane boundary confidence level for each of the plurality of cells of each of the plurality of training input label maps is determined. In a non-limiting example, the lane boundary confidence level includes one of: a no confidence level, a low confidence level a medium confidence level, a high confidence level, and a neutral confidence level. In an exemplary embodiment, the lane boundary confidence level is determined using a heuristic (i.e., rules-based) evaluation of the plurality of training input data.

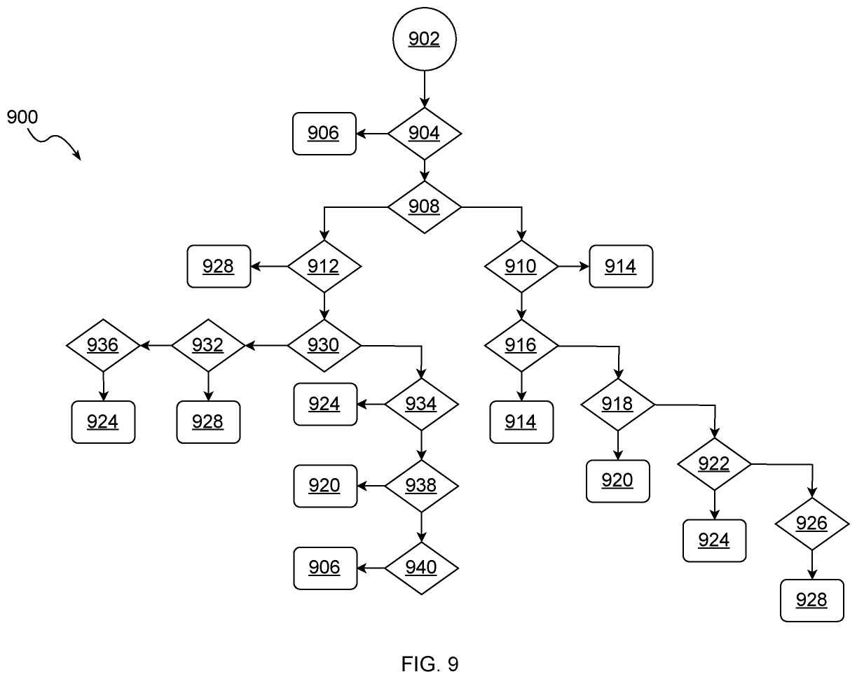

Referring to FIG. 9, an exemplary heuristic confidence decision tree 900 for determining a lane boundary confidence level for a given one of the plurality of cells of one of the plurality of training input label maps (hereinafter referred to as “the given cell”) is shown. The confidence decision tree 900 begins at block 902 and proceeds to block 904. At block 904, if a vehicular accident has occurred within the given cell, the lane boundary confidence level of the given cell is determined to be the no confidence level at block 906. If a vehicular accident has not occurred within the given cell, the confidence decision tree 900 proceeds to block 908.

At block 908, if at least one vehicle is observed in the given cell, the confidence decision tree 900 proceeds to block 910. If no vehicles are observed in the given cell, the confidence decision tree 900 proceeds to block 912, as will be discussed in greater detail below. At block 910, if adverse weather is not observed within the given cell, the lane boundary confidence level of the given cell is determined to be the high confidence level at block 914. If adverse weather is observed within the given cell, the confidence decision tree 900 proceeds to block 916.

At block 916, if multiple vehicles are observed within the training input data, the lane boundary confidence level of the given cell is determined to be the high confidence level at block 914. If only a single vehicle is observed within the training input data, the confidence decision tree 900 proceeds to block 918. At block 918, if an intersection is observed within the given cell, the lane boundary confidence level of the given cell is determined to be the low confidence level at block 920. If an intersection is not observed within the given cell, the confidence decision tree 900 proceeds to block 922.

At block 922, if outer lane boundaries (e.g., the outer lane boundaries 52a) are observed within the given cell, the lane boundary confidence level of the given cell is determined to be the neutral confidence level at block 924. If outer lane boundaries are not observed within the given cell, the confidence decision tree 900 proceeds to block 926. At block 926, if inner lane boundaries (e.g., the inner lane boundaries 52b) are observed within the given cell, the lane boundary confidence level is determined to be the medium confidence level at block 928.

At block 912, if adverse weather is not observed within the given cell, the lane boundary confidence level of the given cell is determined to be the medium confidence level at block 928. If adverse weather is observed within the given cell, the confidence decision tree 900 proceeds to block 930. At block 930, if tire marks (e.g., the tire marks 56) are present in the given cell, the confidence decision tree 900 proceeds to block 932. If tire marks are not present in the given cell, the confidence decision tree 900 proceeds to block 934, as will be discussed in greater detail below.

At block 932, if the tire marks present in the given cell are organized (i.e., arranged in a consistent pattern, for example, parallel to adjacent tire marks), the lane boundary confidence level of the given cell is determined to be the medium confidence level at block 928. If the tire marks present in the given cell are not organized, the confidence decision tree 900 proceeds to block 936. At block 936, if the tire marks present in the given cell are unorganized (i.e., arranged in an inconsistent pattern, for example, where many tire marks are partially or fully perpendicular to other tire marks), the lane boundary confidence level of the given cell is determined to be the neutral confidence level at block 924.

At block 934, if inner lane boundaries (e.g., the inner lane boundaries 52b) are observed within the given cell, the lane boundary confidence level is determined to be the neutral confidence level at block 924. If inner lane boundaries are not observed within the given cell, confidence decision tree 900 proceeds to block 938. At block 938, if outer lane boundaries (e.g., the outer lane boundaries 52a) are observed within the given cell, the lane boundary confidence level of the given cell is determined to be the low confidence level at block 920. If outer lane boundaries are not observed within the given cell, the confidence decision tree 900 proceeds to block 940.

At block 940, if an intersection is observed within the given cell, the lane boundary confidence level of the given cell is determined to be the no confidence level at block 906.

Referring again to FIG. 3, after block 710, the exemplary embodiment 104a proceeds to block 708. At block 708, a plurality of training output label maps are generated based at least in part on the training input data gathered at block 702, the slipperiness condition labels determined at block 704, the one or more updated lane boundary locations determined at block 706, and the lane boundary confidence levels determined at block 710. Each of the plurality of training output label maps corresponds to one of the plurality of training input label maps generated at block 702 and represents a desired output of the machine learning algorithm based on the corresponding training input label map. After block 708, the exemplary embodiment 104a proceeds to block 712.

At block 712, the machine learning algorithm is trained using the plurality of training input label maps and the plurality of training output label maps. In a non-limiting example, the machine learning algorithm includes multiple layers, including an input layer and an output layer, as well as one or more hidden layers. The input layer receives input label maps as inputs. The inputs are then passed on to the hidden layers. Each hidden layer applies a transformation (e.g., a non-linear transformation) to the data and passes the result to the next hidden layer until the final hidden layer. The output layer produces an output label map based on the input label map.

To train the machine learning algorithm, a dataset including the plurality of training input label maps and their corresponding training output label maps is used. The algorithm is trained by adjusting internal weights between nodes in each hidden layer to minimize prediction error. During training, an optimization technique (e.g., gradient descent) is used to adjust the internal weights to reduce the prediction error. The training process is repeated with the entire dataset until the prediction error is minimized, and the resulting trained model is then used to produce output label maps based on novel input label maps.

After sufficient training of the machine learning algorithm, the algorithm is capable of accurately and precisely generating output label maps based on the input label maps. By adjusting the weights between the nodes in each hidden layer during training, the algorithm “learns” to recognize patterns in input label maps that are indicative of characteristics of output label maps.

It should be understood that the machine learning algorithm may be any kind of machine learning algorithm configured to generate output label maps based on input label maps, including for example, learned generative model algorithms, such as a generative adversarial network (GAN) algorithm, a convolutional neural network (CNN) algorithm, a reinforcement learning algorithm, and/or the like, without departing from the scope of the present disclosure.

After block 712, the exemplary embodiment 104a is concluded, and the method 100 proceeds as discussed above.

The system 10 and method 100 of the present disclosure offer several advantages. For example, due to dynamic road conditions, detailed maps of roadways stored on-vehicle (e.g., in the media 22 of the vehicle controller 14) and/or off-vehicle (e.g., in the server database 34) may become outdated. In some instances, obstructions such as, for example, roadway defects (e.g., a pothole on or near the roadway), foreign objects (e.g., debris from a vehicular collision on or near the roadway), traffic-related obstructions (e.g., a disabled vehicle stopped on or near the roadway), weather-related obstructions (e.g., a snowbank on or near the roadway), and/or the like may dynamically appear on the roadway. The likelihood of obstructions appearing on the roadway may increase during adverse weather conditions. Therefore, by updating detailed maps using the system 10 and method 100 of the present disclosure, the accuracy and performance of automated driving systems which utilize the detailed maps are increased.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for updating a road map for a vehicle, the system comprising:
a plurality of vehicle sensors; and
a vehicle controller in electrical communication with the plurality of vehicle sensors, wherein the vehicle controller is programmed to:
gather input data about an environment surrounding the vehicle using the plurality of vehicle sensors, wherein the input data includes at least one abnormal traffic pattern indication;
generate an input label map based at least in part on the input data;
generate a vehicle output label map based at least in part on the input label map, wherein the vehicle output label map is generated using a machine learning algorithm; and
perform a first action based at least in part on the vehicle output label map.

2. The system of claim 1, wherein the plurality of vehicle sensors includes at least one of: a perception sensor and a vehicle communication system, and wherein to gather the input data, the vehicle controller is further programmed to:
receive the input data using at least one of: the perception sensor and the vehicle communication system.

3. The system of claim 1, wherein the input data includes at least: one or more remote vehicle location histories, one or more lane boundary locations, and the at least one abnormal traffic pattern indication.

4. The system of claim 3, wherein the at least one abnormal traffic pattern indication includes at least one of: a deviation of the one or more remote vehicle location histories from the one or more lane boundary locations and one or more tire marks in the environment surrounding the vehicle.

5. The system of claim 1, wherein the input label map is a two-dimensional matrix of a plurality of cells, wherein each of the plurality of cells represents a portion of the environment surrounding the vehicle, and wherein each of the plurality of cells includes a label based at least in part on the input data.

6. The system of claim 1, wherein to generate the vehicle output label map, the vehicle controller is further programmed to:
provide the input label map to an input layer of the machine learning algorithm, wherein the machine learning algorithm is a generative adversarial network (GAN) algorithm configured to generate the vehicle output label map based on the input label map; and
receive the vehicle output label map from an output layer of the machine learning algorithm, wherein the vehicle output label map includes one or more updated lane boundary locations based at least in part on the at least one abnormal traffic pattern indication and one or more road-surface condition labels, and wherein each of the one or more updated lane boundary locations includes a lane boundary confidence level.

7. The system of claim 6, wherein the machine learning algorithm is trained using a plurality of training input label maps, wherein each of the plurality of training input label maps has been generated based at least in part on a heuristic evaluation of a plurality of training input data.

8. The system of claim 1, wherein the system further comprises an automated driving system in electrical communication with the vehicle controller, and wherein to perform the first action, the vehicle controller is further programmed to:
adjust an operation of the automated driving system based at least in part on the vehicle output label map.

9. The system of claim 1, wherein the plurality of vehicle sensors further includes a vehicle communication system, and wherein to perform the first action, the vehicle controller is further programmed to:
transmit the input data to a remote server system using the vehicle communication system; and
transmit the vehicle output label map to the remote server system using the vehicle communication system.

10. The system of claim 9, wherein the remote server system includes:
a server communication system;
a server controller in electrical communication with the server communication system, wherein the server controller is programmed to:
receive a plurality of input data from one or more vehicles using the server communication system;
receive a plurality of vehicle output label maps from the one or more vehicles using the server communication system;
generate a server output label map based at least in part on the plurality of input data from the one or more vehicles;
generate a combined output label map based at least in part on the plurality of vehicle output label maps from the one or more vehicles and the server output label map; and
transmit the combined output label map to the one or more vehicles using the server communication system.

11. A method for updating a road map, the method comprising:
gathering input data;
generating an input label map based at least in part on the input data;
generating a vehicle output label map based at least in part on the input label map, wherein the vehicle output label map is generated using a machine learning algorithm; and
performing a first action based at least in part on the vehicle output label map.

12. The method of claim 11, wherein gathering the input data further comprises:
performing a plurality of measurements using a plurality of vehicle sensors, wherein the plurality of vehicle sensors includes at least one perception sensor.

13. The method of claim 11, wherein gathering the input data further comprises:
receiving the input data from one or more remote vehicles.

14. The method of claim 11, wherein gathering the input data further comprises:
gathering input data, wherein the input data includes at least: one or more remote vehicle location histories, one or more lane boundary locations, and at least one abnormal traffic pattern indication, and wherein the at least one abnormal traffic pattern indication includes at least one of: a deviation of the one or more remote vehicle location histories from the one or more lane boundary locations and one or more tire marks in an environment surrounding a vehicle.

15. The method of claim 14, wherein generating the input label map further comprises:
generating the input label map, wherein the input label map is a two-dimensional matrix of a plurality of cells, wherein each of the plurality of cells represents a portion of the environment surrounding the vehicle, and wherein each of the plurality of cells includes a label based at least in part on the input data.

16. The method of claim 15, wherein generating the vehicle output label map further comprises:
providing the input label map to an input layer of the machine learning algorithm, wherein the machine learning algorithm is a generative adversarial network algorithm configured to generate the vehicle output label map based on the input label map; and
receiving the vehicle output label map from an output layer of the machine learning algorithm, wherein the vehicle output label map includes one or more updated lane boundary locations based at least in part on the at least one abnormal traffic pattern indication and one or more road-surface condition labels based at least in part on the at least one abnormal traffic pattern indication, and wherein each of the one or more updated lane boundary locations includes a lane boundary confidence level.

17. The method of claim 11, wherein performing the first action further comprises:
transmitting the vehicle output label map to one or more remote vehicles; and
adjusting an automated driving system of the one or more remote vehicles based at least in part on the vehicle output label map.

18. A system for updating a road map for a vehicle, the system comprising:
a vehicle system including:
a plurality of vehicle sensors including at least a perception sensor and a vehicle communication system;
an automated driving system; and
a vehicle controller in electrical communication with the plurality of vehicle sensors and the automated driving system, wherein the vehicle controller is programmed to:
gather input data about an environment surrounding the vehicle using the plurality of vehicle sensors, wherein the input data includes at least: one or more remote vehicle location histories, one or more lane boundary locations, and at least one abnormal traffic pattern indication, and wherein the at least one abnormal traffic pattern indication includes at least one of: a deviation of the one or more remote vehicle location histories from the one or more lane boundary locations and one or more tire marks in the environment surrounding the vehicle;
generate an input label map based at least in part on the input data, wherein the input label map is a two-dimensional matrix of a plurality of cells, wherein each of the plurality of cells represents a portion of the environment surrounding the vehicle, and wherein each of the plurality of cells includes a label based at least in part on the input data;
generate a vehicle output label map based at least in part on the input label map, wherein the vehicle output label map is generated using a machine learning algorithm;
adjust an operation of the automated driving system based at least in part on the vehicle output label map;
transmit the input data to a remote server system using the vehicle communication system; and
transmit the vehicle output label map to the remote server system using the vehicle communication system.

19. The system of claim 18, wherein the remote server system further comprises:
a server communication system; and
a server controller in electrical communication with the server communication system, wherein the server controller is programmed to:
receive a plurality of input data from the vehicle system using the server communication system;
receive a plurality of vehicle output label maps from the vehicle system using the server communication system;
generate a server output label map based at least in part on the plurality of input data from the vehicle system;
generate a combined output label map based at least in part on the plurality of vehicle output label maps from the vehicle system and the server output label map; and
transmit the combined output label map to the vehicle system using the server communication system.

20. The system of claim 19, wherein to generate the vehicle output label map, the vehicle controller is further programmed to:
provide the input label map to an input layer of the machine learning algorithm, wherein the machine learning algorithm is a generative adversarial network algorithm configured to generate the vehicle output label map based on the input label map; and
receive the vehicle output label map from an output layer of the machine learning algorithm, wherein the vehicle output label map includes one or more updated lane boundary locations based at least in part on the at least one abnormal traffic pattern indication and one or more road-surface condition labels based at least in part on the at least one abnormal traffic pattern indication, and wherein each of the one or more updated lane boundary locations includes a lane boundary confidence level; and
wherein to generate the server output label map, the server controller is further programmed to:
provide the input label map to an input layer of the machine learning algorithm, wherein the machine learning algorithm is a generative adversarial network algorithm configured to generate the server output label map based on the input label map; and
receive the server output label map from an output layer of the machine learning algorithm, wherein the server output label map includes one or more updated lane boundary locations based at least in part on the at least one abnormal traffic pattern indication and one or more road-surface condition labels based at least in part on the at least one abnormal traffic pattern indication, and wherein each of the one or more updated lane boundary locations includes a lane boundary confidence level.
